(19) United States
(12) Patent Application Publication
(10) Pub. No.: US 2006/0027982 A1
(43) Pub. Date: Feb. 9, 2006

(54) Kneeboard device and method of attaching a person to a snowboard deck

(76) Inventors: David Smith, Lakewood, CO (US); Corey Smith, Lakewood, CO (US)

Correspondence Address: JOHN R LEY, LCC, 5299 DTC BLVD, SUITE 610, GREENWOOD VILLAGE, CO, 80111, US

(21) Appl. No.: 10/914,597

(22) Filed: Aug. 9, 2004

(51) Int. Cl. B62B 13/00

(52) U.S. Cl. 280/27

(57) ABSTRACT

A kneeboard device supports the knees and feet of a person in a kneeling position on a snowboard deck for sliding down a snowy slope for recreational entertainment. A knee support engages and supports the person's knees above the deck while a foot support supports the person's feet. The knee support and foot support includes straps to attach the person's leg and foot to the knee support and foot support, respectively. The kneeboard device is controllable in direction and speed.

This invention relates to winter recreational sports equipment. More particularly, the present invention relates to a new and improved kneeboard and kneeboard binding which permits a person to be secured to a kneeboard or snowboard deck in a kneeling position and thereby allows the person to slide down a snowy slope in a kneeling position with enhanced maneuverability for entertainment and enjoyment.

### BACKGROUND

Skiing has been a popular winter recreational sport for decades. Snow skiing involves attaching a person's feet to two elongated structures or skis to allow the person to slide down a snow covered hill or ski slope at a ski resort. The skis each have a bottom surface with a low friction coating and a metal edge for carving into the snow to allow the person to turn and stop. Ski resorts have been developed to service skiers by maintaining the snow covered hills and providing lifts to carry the skiers from the bottom of the ski slope to the top of the ski slope. More recently, snow boarding has gained popularity and is now an accepted activity at resorts.

People generally try other snow sports like snowboarding to have an experience that is different from skiing. Snowboarding involves sliding down the ski slope on a single board or snowboard deck similar to riding a skateboard or a surfboard because the person stands upright and sideways and leans forward or backward to turn. The snowboard has bindings that attach to the deck to secure the snowboard to the user's feet. Snowboards also have bottoms with low friction properties on snow, and edges for carving into snow for turning and stopping the snowboard.

Other types of sports equipment used in winter recreational sports has evolved over the last century and continues to change into the future, but the alternative types of recreational equipment have not achieved popularity of skiing and snowboarding. Snowbikes allow people to sit down and steer a pair of handlebars like a bicycle when traveling down the slope. Mono-skis have a person standing with their feet next to one another facing down hill on a single ski like device.

The expense of new equipment slows the evolution of winter sports equipment. New equipment such as snow bikes are relatively expensive and are not as widely available as traditional skis and snowboards. Rental shops are less likely to carry new types of equipment because of their initial cost and the risk that there will not be a sufficient number of rentals to pay for the equipment. Therefore someone wanting to try a new type of equipment is often required to purchase the new equipment. This is not a very appealing prospect for most people because the equipment may cost several hundred dollars, and the person may not even enjoy the experience of using the equipment.

The inability to use some winter sports equipment at a ski resort is another impediment to the evolution of new equipment. Many new devices have substantially no controls for steering or stopping and are therefore unsuitable for use on a ski slope at a ski resort. Some of these types of devices lack an edge or other mechanism to carve into the slope for turning or stopping. Other of these devices are not adequately secured to the user, and can become dangerous projectiles speeding down the slope after coming free from the user in a crash. These types of devices are usually relegated to the sled hills.

### SUMMARY OF THE INVENTION

In general, the present invention pertains to a recreational device for attaching to a person for sliding down a ski slope. A kneeboard provides the user with a new and challenging experience by attaching a snowboard deck to the user while the user is in a kneeling position. The kneeboard binding attaches the legs and feet of the user to the snowboard deck with the user facing forward while traveling down the ski slope. The person uses their feet and legs to maneuver and stop and can bend their knees to shift their weight forward or rearward. Since the kneeboard binding can be attached to a standard snowboard deck, people who already have snowboards can detach the snowboard bindings from the deck and attach the kneeboard binding, thereby reducing the expense of kneeboarding by reusing the snowboard deck.

In accordance with these considerations, the kneeboard device of the present invention is for attaching to a person so that the person can slide down a slope. The kneeboard device comprises a deck having an upper surface and a lower surface on the opposite side from the upper surface, with the lower surface having a relatively low frictional resistance with snow and having metal edging. The kneeboard device also includes a knee support connected to the deck for receiving and supporting a knee of the person, and a foot support connected to the deck for receiving and retaining a foot of the person.

In another aspect of the present invention involves a kneeboard binding for attaching a person to a snowboard deck so that the person can slide down snow on a slope. The binding includes a knee support connected to the deck for receiving and supporting a knee of the person and a foot support connected to the deck for receiving a foot of the person. The binding can also include straps for connecting the person to the knee support and foot support.

The present invention, in another aspect, involves attaching a person to a snowboard deck for recreational purposes. The person is supported on the snowboard deck by supporting a knee of the person with a knee support that is connected to the deck and by supporting a foot of the person with a foot support that is connected to the deck.

A more complete appreciation of the scope of the present invention and the achievement of the above-noted beneficial aspects can be obtained by reference to the following detailed description of presently preferred embodiments taken in connection with the accompanying drawings, which are briefly summarized below, and by reference to the appended claims.

### BRIEF DESCRIPTION OF THE DRAWINGS

FIG. 1 is a perspective view of a kneeboard and kneeboard bindings which incorporates the present invention shown in use by a person with a pair of poles on a snow covered slope.

FIG. 2 is an enlarged perspective view of the kneeboard and kneeboard bindings shown in FIG. 1, with leg straps shown detached from the kneeboard bindings.

FIG. 3 is an enlarged perspective view of a knee support of the kneeboard bindings shown in FIG. 1.

FIG. 4 is an enlarged side elevation view of the knee support shown in FIG. 1.

FIG. 5 is an enlarged top plan view of the knee support shown in FIG. 2.

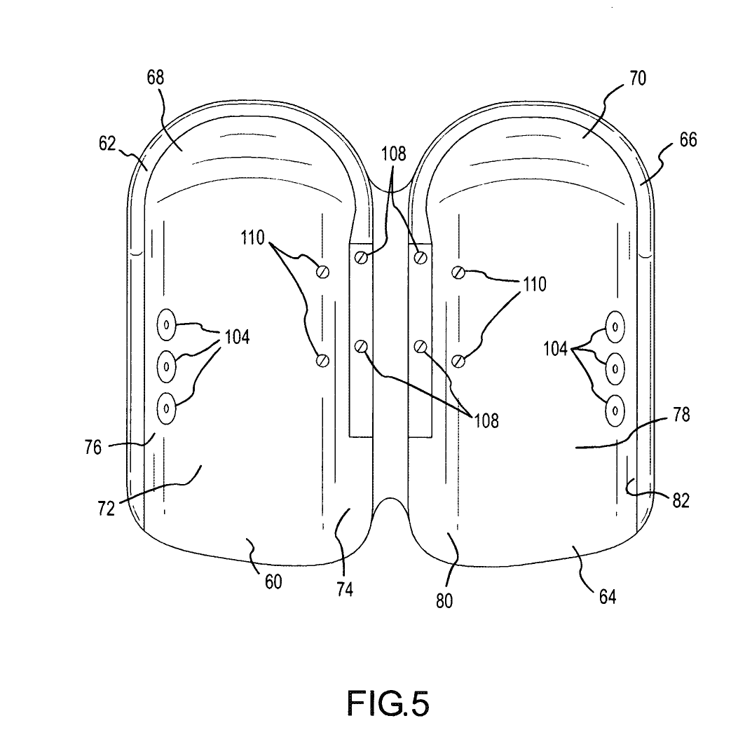

FIG. 6 is an enlarged perspective view of a base support of the knee support shown in FIG. 1.

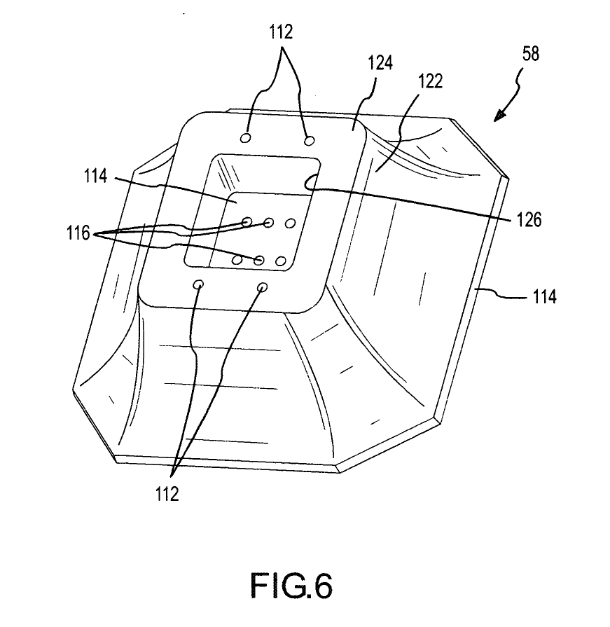

FIG. 7 is an enlarged perspective view of a foot support of the kneeboard bindings shown in FIG. 1.

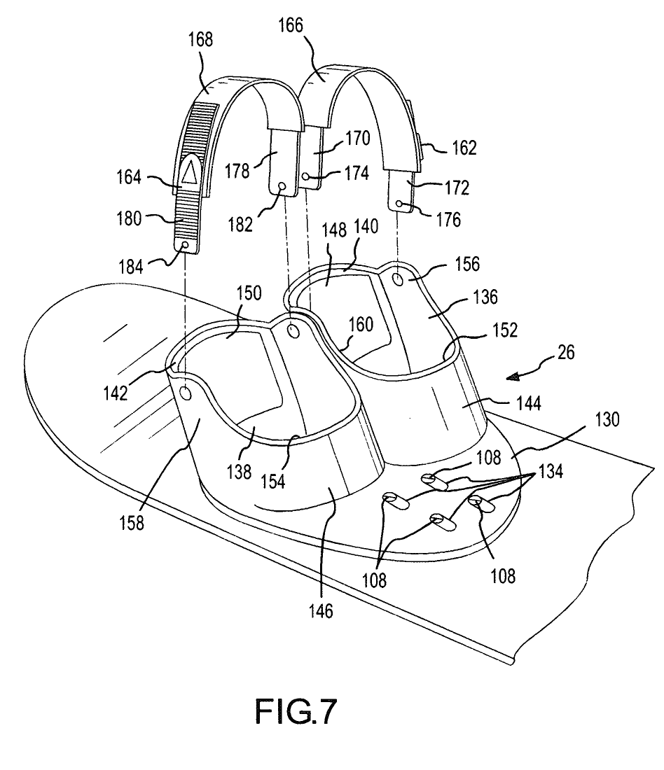

FIG. 8 is an enlarged side elevation view of the foot support shown in FIG. 1.

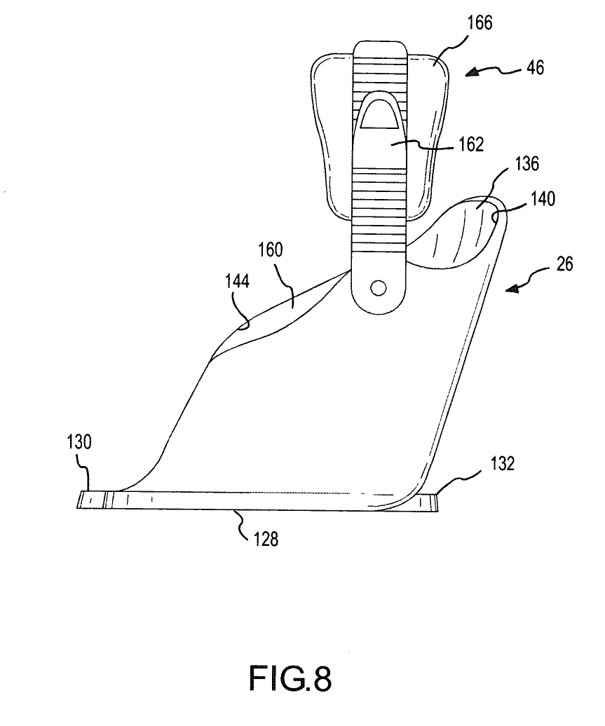

FIG. 9 is an enlarged top plan view of the foot support shown in FIG. 2.

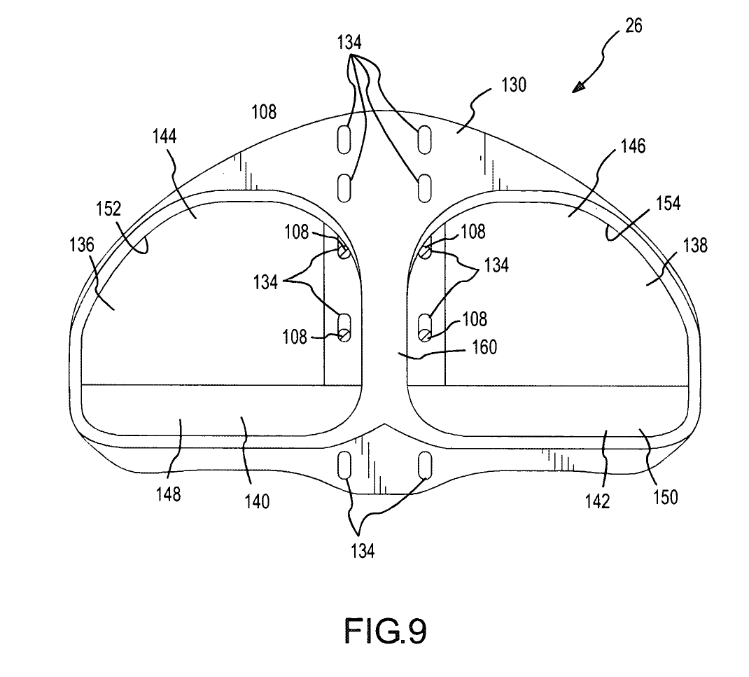

### DETAILED DESCRIPTION

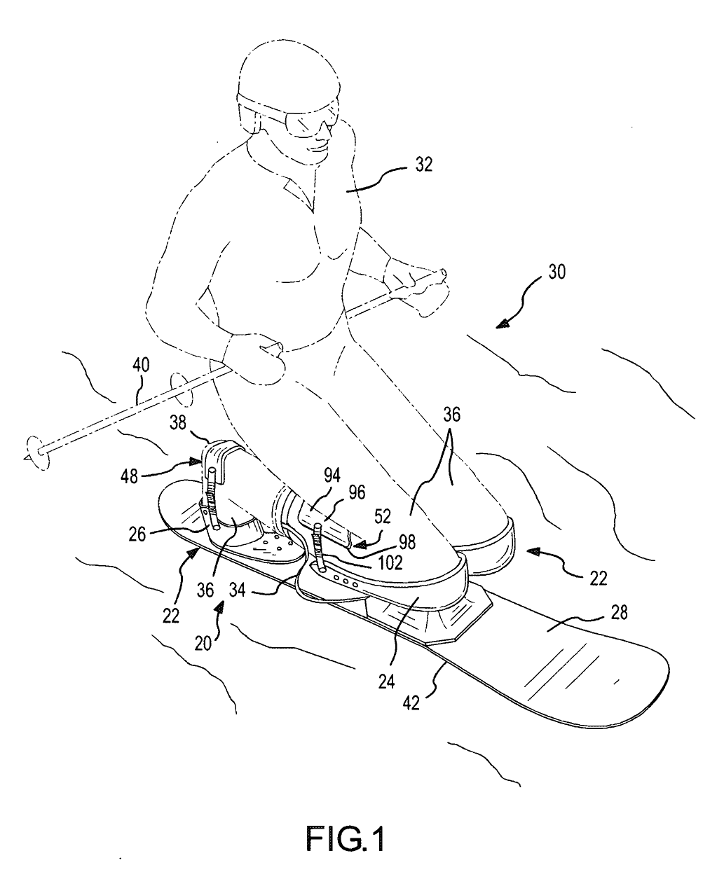

A kneeboard 20 incorporating the present invention is shown in FIG. 1. The kneeboard 20 is for attaching to a person or user 32 to allow the user 32 to slide down a ski slope 30 while positioned on his or her knees and facing down the slope 30. The kneeboard 20 includes a conventional snowboard deck 28, (a snowboard without the snowboard bindings), with a bottom surface (not shown) that contacts snow on the ski slope 30 and slides across the snow. The snowboard deck 28 also includes metallic edges 42 for controlling and maneuvering the kneeboard 20. The edges 42 are preferably formed into the bottom of the deck 28 and are a conventional type used on snowboards for cutting into snow. A kneeboard binding 22 is for attaching the user 32 to a conventional snowboard deck 28. The kneeboard in FIG. 1 includes the deck 28 and the kneeboard bindings 22. The kneeboard bindings 22 includes a knee support 24 and a foot support 26 which are mounted to the snowboard deck 28 in forward and rearward positions, respectively. The kneeboard is ridden down a snow covered hill or ski slope 30 by a person or user 32 that is positioned with their knees 36 on the knee support 24 and their feet 38 in the foot support 26. The user 32 can have a pair of poles 40 to aid the user 32 in maneuvering.

The user 32 rides the kneeboard 20 generally facing down the slope 30. The kneeboard 20 is turned from one direction to another by leaning the deck 28 at an angle with respect to the surface of the ski slope 30.

The knee support 24 is secured to the deck 28 positioned forward and spaced apart from the foot support 26. The knee support 24 contacts and restrains the knees 36 and shins of the user 32 in a position relative to the foot support 26 so that the foot support is aligned with the user's feet 38.

The foot support 26 is secured to the deck 28 rearward and spaced apart from the knee support 24. In this position, the feet 38 of the user 32 are aligned with the foot support 26 when the knee support 24 is supporting the knees of the user 32. Having the foot support 26 and knee support 24 longitudinally spaced apart allows the deck 28 to flex normally so that it can assist in absorbing bumps and help to turn.

The kneeboard 20 is preferably attached to the user 32 with four straps, one strap around each calf and one strap around the heel of each of the feet 38. When using the kneeboard 20, the user 32 is typically dressed in warm winter clothes and wears a pair of heavy duty snowboarding type boots. The user 32 kneels onto the knee support 24 and the knees 36 are held to the knee support 24 by extending leg connectors or calf straps 50 and 52 over the user's calves and securing the calf straps 50 and 52 to the knee support 24. The user's feet 38 are placed into the foot support 26 and foot connectors or foot straps 46 and 48 are extended over the heels of the feet 38 and secured to the foot support 26. In this way, the kneeboard 20 is attached to the user 32 at the user's calves and feet 38. This allows the user's knees 36 to bend and extend to position the user 32 kneeling on the kneeboard 20, and allow the user 32 to raise or lower his or her body for maneuvering, to absorb bumps or to perform tricks.

The kneeboard 20 also includes a safety strap 34 that is attached to the knee support 24 and extends to and wraps around the leg of the user 32. The safety strap 34 is a conventional type safety strap that is required on snowboards and skis that do not have brakes.

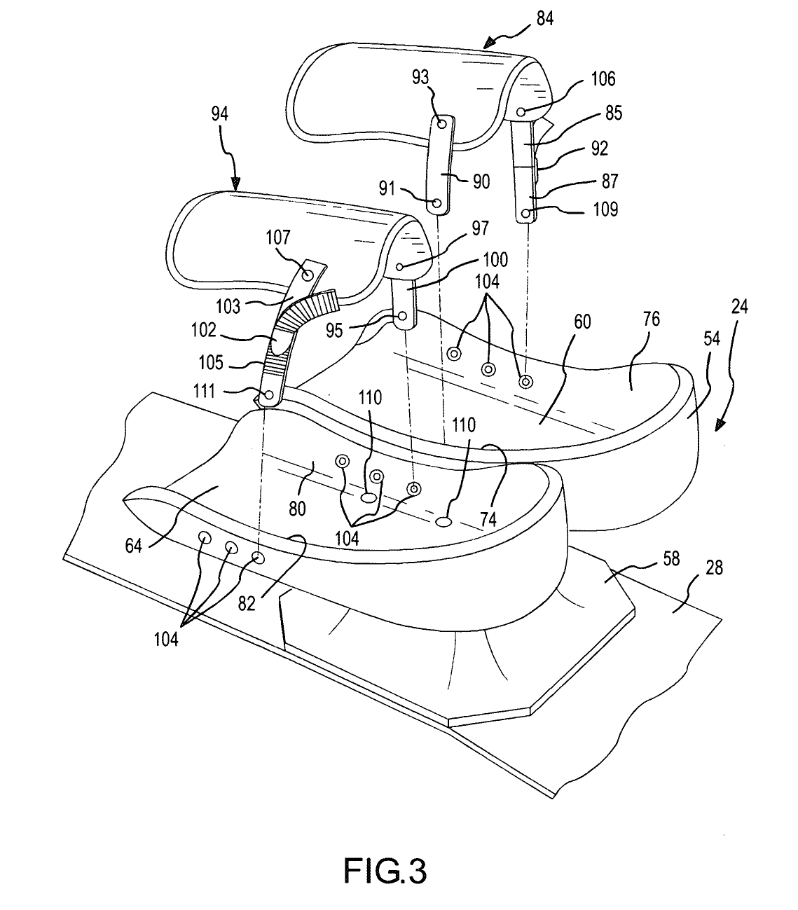

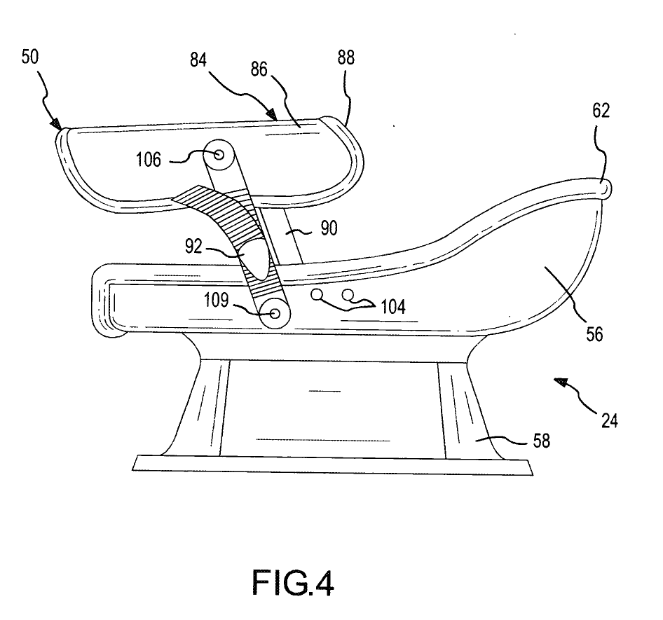

The knee support 24 includes an upper support portion 54 and a base 58. The base 58 is connected between the upper support portion 54 and the deck 28 and attaches the support portion 54 to the deck 28. The upper support 54 is contoured to engage and support the user's knees, as shown in FIG. 3. The upper support 54 includes a support shell 56 that is preferably formed from injection molded plastic. The support shell 56 can be made from other materials so long as the shell 56 is strong enough to support the weight of the user 32 under various conditions of use. The upper support 54 include left and right recessed channels 60 and 64, (FIG. 4), for receiving the user's left and right legs, respectively. The left and right channels 60 and 64 include left and right pads 62 and 66 respectively. The pads 62 and 66 include a foam material that is formed to cover a portion of the support shell 56 at the channels 60 and 64 and the pads 62 and 66 are covered with a durable flexible sheet covering. The channels 60 and 64 engage the knee and shin area of the user 32 in an area on the legs that is preferably from about midway between the user's knee 36 and foot 38 to the knee. The channels 60 and 64 restrain the user's legs from moving forward or side to side when the user is strapped in, and also distribute the weight of the user to provide a comfortable and secure connection to the kneeboard 20.

The left channel 60 includes a bottom portion 72, with an inner side 74 and an outer side 76 on opposite transverse sides of the bottom portion 72 and extending away and upward from the bottom portion 72. The right channel 64 is similarly configured with a bottom portion 78, an inner side 80 and an outer side 82. The inner sides 74 and 80 engage the insides of the user's legs and prevent the legs from moving transversely toward the center of the kneeboard 20. The outer sides 76 and 82 engage the outsides of the user's legs and prevent them from moving transversely away from the center of the kneeboard 20. This way by moving the user's legs, the user 32 can manipulate the kneeboard 20 to turn or stop.

The left channel 60 includes a rounded knee cup 68 and the right channel 64 includes a rounded knee cup 70 that are at the forward or downhill end of the upper support 54. The knee cups 64 and 68 engage the user's knees 36 to prevent the user from sliding forward in the kneeboard binding 22. This is particularly important when the user is sliding down the hill and the kneeboard 20 encounters some resistance such as a bump, because the kneeboard 20 will tend to slow down quickly while the momentum of the user 32 tries to continue forward. Having the knee cups 64 and 68 makes the kneeboard 20 continue at the same rate as the user 32 so that the user 32 stays on the kneeboard 20.

Calf straps 50 and 52 restrain the left and right channels 60 and 64, respectively, to the user 32. The left calf strap 50 includes a left calf holder 84 with a shell 86 that is preferably injection molded plastic and is shaped to wrap part way around the user's calf. The left calf holder 84 also includes a calf holder pad 88 that is foam with a sheet material covering and which contacts the calf area of the user 32. The left calf holder 84 is attached to the left channel at the inner side 74 with an inner strap 90 and to the outer side 76 with an upper buckle strap 85 and a lower buckle strap 87 that are connected together with an adjustable buckle 92. The right calf strap 52 is similar to the left, with a calf holder 94, a shell 96, a pad 98, an inner strap 100 and an adjustable buckle 102 which connects together an upper buckle strap 103 and a lower buckle strap 105.

The upper buckle strap 85 is connected at one end to the left calf holder 84 and at another end to the adjustable buckle 92. The lower buckle strap 87 is connected at one end to the outer side 76 of the left channel 60. The adjustable buckle 92 connects the upper buckle strap 85 to the lower buckle strap 87 at various points so that the outer side 76 and the left calf holder 84 can be secured together at varied distances. The adjustable buckle 102 interacts with the upper buckle strap 103 and the lower buckle strap 105 in the same manner as the adjustable buckle 92. Alternatively, the adjustable buckles 92 and 102 can be attached directly to the left and right calf holders 84 and 94, respectively, thereby eliminating the need for the upper buckle straps 85 and 103.

The adjustable buckles 92 and 102 adjust the position of the calf holders 84 and 94 to fit users with different sized calves. The buckles 92 and 102 are preferably a ratchet type that are used on snow board bindings, however other buckles or adjustable straps could also be used so long as they are strong enough to secure the user to the kneeboard 20. The upper buckle straps 85 and 103 are connected to the left and right calf holders 84 and 94, respectively, with pivot connections 106 and 107. The lower buckle straps 87 and 105 are connected to the left and right outer sides 76 and 82, respectively, with pivot connections 109 and 111.

The overall length of the calf straps 50 and 52 are adjustable with the adjustable buckles 92 and 102 by adjusting the location at which the adjustable buckles 92 and 102 attach to the lower buckle straps 87 and 105, respectively.

The inner strap 90 is attached to the inner side 74 of the channel 60 with a pivot connection 91 and to the calf holder 84 with a pivot connection 93. The inner strap 100 is attached to the inner side 80 with a pivot connection 95 and to the calf holder 94 with a pivot connection 97. The pivot connections 91, 93, 106, 107, 109 and 111 attache to the channels 60 and 64 at attachment inserts 104. The pivot connections 91, 93, 106, 107, 109 and 111 allows the calf holders 84 and 94 to pivot with respect to the channels 60 and 64, and can be can be bolts, rivets or similar devices. Having the calf holders 84 and 94 connected to the upper support 54 with pivot connections allows the user to adjust the longitudinal position at which the calf holders 84 and 94 contact the calves of the user 32. The longitudinal position of the calf holders 84 and 94 can also be used to hold the knees 36 in the knee cups 68 and 70. By positioning the calf holders 84 and 94 rearward and tightening the buckles 92 and 102 more longitudinally forward force is applied to the user's legs and the knees 36 are more firmly engaged in the cups 68.

The buckles 92 and 102 adjust to tighten the calf holders 84 and 94 against the calves of the user 32. Tightening the buckles causes the user's legs to be held in the channels 60 and 64 which secures the position of the knee and leg of the user with respect to the kneeboard 20. The pivot connections 91, 95, 109 and 111 can also be adjusted forward or rearward by moving them from one buckle attachment insert 104 to another. The inserts 104 provide a secure fastening position for the pivot connections 91, 95, 109 and 111, and are preferably made from a metal that is attached to the channels 60 and 64. Adjusting the calf holders 84 and 94 forward or rearward allows the knee support 24 to be adjusted to fit smaller or larger users calves, and allows the kneeboard binding 22 to be adjusted for comfort.

The base 58 is positioned between the shell 56 and the deck 28 and positions the shell 56 elevated above the surface of the deck 28 to position where the user 32 can lean and turn the deck 28. The base 58 is attached to the upper support 54 with four screws 110 that extend through the shell 56 of the upper support 54 and screw into threaded inserts 112 in the base 58. The base 58 is preferably injection molded from plastic includes a reinforcing metal plate (not shown) molded into the bottom 114 to strengthen the base 58 where it contacts the deck 28. The base 58 is mounted to the deck 28 with mounting screws 108 that extend through the bottom 114 and the plate. The bottom 114 of the base 58 includes an area that is relatively large, extending nearly from one edge to the other of the deck 28. The size of the bottom 114 provides for a larger area over which the user's weight is distributed. Distributing the user's weight over a relatively large area helps to prevent the deck 28 from becoming over stressed and breaking, especially when the user is leaning to one side and lateral force is applied. The width of the bottom 114 of the base 58 also decreases the leverage on relatively narrowly spaced mounting screws 108 which reduces the chance that a mounting screw 108 will be pulled out of the deck 28.

The bottom 114 includes a series of mounting holes 116 for mounting the base 58 to the deck 28 with the mounting screws 108. Decks 28 are typically manufactured for either three screw or four screw binding attachment. The mounting holes 116 in the base bottom 114 can be in a rectangular type series for attaching to the deck 28 with four screws, as shown or can be arranged to align with three hole decks. The base bottom 114 includes more than enough holes 116 so that the base 58 can be mounted forward or rearward on the deck 28, depending on if the rearward holes 116 are used or the forward holes 116 are used, respectively. Moving the base 58 forward or rearward moves the longitudinal position of the upper support 54 and the user 32 which thereby adjust the user's weight distribution on the kneeboard 20. The longitudinal positioning of the base 58 also allows for adjustment to make the kneeboard binding 22 fit various sizes of users 32. The base bottom 114 and the mounting screws 108 can be accessed through slots 118 and 120 in the upper support 54, (FIG. 4), or by removing the upper support 54 from the base 58.

A top 122 of the base 58 includes a shelf 124 that surrounds and defines an interior hollow 126 of the base 58. The top 122 is smaller than the bottom 114 and the base 58 tapers from the bottom 114 to the top 122. The inserts 112 are preferably molded into the shelf 124 and are positioned so that when the screws 110 are inserted through the upper support 54 they are not directly under the pads 62 and 66 in the bottom portions 72 and 78 of the channels 60 and 64. Rather the screws are positioned under the pads 62 and 66 toward the inner sides 74 and 80 of the upper support 54 where there is less pressure from the legs so that the screws 110 do not create a point of discomfort for the user 32.

The base 58 positions the user 32 elevated above and away from the surface of the deck 28. This allows the user 32 to make sharper turns by leaning the kneeboard 20 without dragging the knees 36 on the snow, than would be possible with the user 32 closer to the deck. The base 58 is also beneficial in that it provides the user 32 with greater leverage for turning the kneeboard 20 since the user 32 is elevated above the surface of the deck 28. The base 58 can be made in many different heights depending on the desires of the user 32. In addition, the base 58 can be made with a standard height and spacers, (not shown), could be inserted between the base 58 and the upper support 54 to raise the upper support 54 further from the deck 28.

In addition to supporting and attaching to the knees 36 of the user 32, the kneeboard binding 22 attaches to the feet 38 of the user 32 with the foot support 26. Attaching to the feet 38 gives the user 32 additional leverage on the kneeboard 20, above that provided with just the knee support 24, for maneuvering the kneeboard 20 when traveling down the slope 30 in order to make turns and to stop.

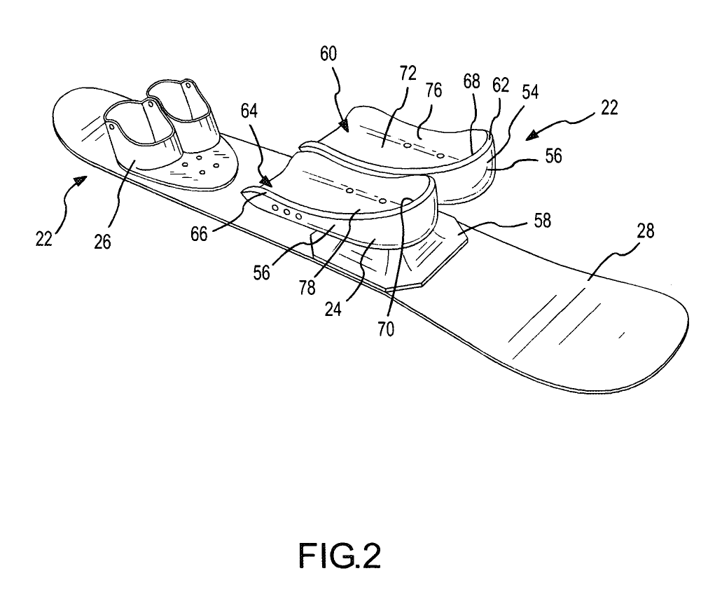

The foot support 26, as shown in FIGS. 1 and 2, is preferably injection molded from plastic with a plate (not shown) integrally molded in a bottom 128 to provide structural strength for mounting to the deck 28.

The bottom 128 includes a front flange 130 and a rear flange 132 and also includes a series of mounting holes 134. Four mounting screws 108 extend through the mounting holes 134 to secure the foot support 26 to the deck 28. The mounting holes 134 are arranged in a series so that the foot support 26 can be mounted forward or rearward depending on if the rearward or forward mounting holes 134 are used, respectively. With the series of mounting holes 134, the foot support 26 can be adjusted to fit users of different sizes by moving the foot support 26 closer or farther from the knee support 24.

In an alternative to mounting the foot support 26 with four mounting screws 108 in a rectangular pattern, the foot support 26 can be mounted with other numbers or patterns of mounting screws such as three. The mounting screws 108 that are in the front flange 130 are accessible in the front of the foot support 26, the mounting screws 108 toward the middle of the foot support 26 are accessible through left and right toe holes 136 and 138. The mounting holes can be round or slotted to provide more adjustment variations.

The left and right toe holes 136 and 138 are for receiving the toe portion of the user's feet 38. The toe holes 136 and 138 are shaped to receive the toe portion of boots of the user 32 and include a left back portion 140 and a right back portion 142 that alignment with and restrain the bottoms of the feet 38 of the user 32. The toe holes 136 and 138 also include a left front portion 144 and a right front portion 146 for restraining the tops of the user's feet 38.

The back portions 140 and 142 prevent the feet 38 from moving out of the toe holes 136 and 138 in a rearward direction. The back portions 140 and 142 are angled slightly upward and rearward with respect to the bottom 128, which allows the feet 38 of the user 32 to be angled slightly forward in a comfortable position that permits the users 32 feet 38 to press against the back portions 140 and 142 and allows the feet 38 to help the user 32 to shift weight from side to side and to turn. The back portions 140 and 142 are covered with grip tape 148 and 150, respectively, also for aiding the user 32 in maneuvering the kneeboard 20.

The front portions 144 and 146 of the toe holes 136 and 138 are for retaining the tops of the user's feet 38. The front portions 144 and 146 prevent the feet 38 from moving forward out of the toe holes 136 and 138. To provide a comfortable and secure fit with boots, the front portions 144 and 146 include front pads 152 and 154. The front pads 152 and 154 are preferably made from a foam type material with a sheet covering and extend around the inside of the toe holes 136 and 138 at the front portions 144 and 146. In addition to providing a comfortable surface for the top of the feet 38 of the user 32, the pads 152 and 154 also protect the boots from wear.

The toe holes 136 and 138 also include exterior side walls 156 and 158 and a divider wall 160 that is between the toe holes 136 and 138. The exterior side wall 156 creates the transversely outside wall of the left toe hole 136 and the exterior side wall 158 creates the transversely outside wall of the right toe hole 138. The side walls 156 and 158 prevent the feet 38 of the user 32 from moving out of the toe holes 136 and 138 transversely away from foot support 26. The divider wall 160 forms the inner wall of the toe holes 136 and 138 and prevents the feet 38 of the user 32 from moving inward toward one another.

The toe holes 136 and 138 are preferably deep enough so that when the feet 38 are inserted into the holes 136 and 138, the feet 38 cannot move substantially horizontally. That is to say, the feet 38 are only movable vertically up and out of the toe holes 136 and 138. To complete the restraint of the user's feet 38, the foot support 26 utilizes the foot straps 46 and 48 to prevent the feet 38 from moving vertically out of the toe holes 136 and 138.

The foot straps 46 and 48 extend around the heels of the feet 38 to prevent them from moving out of the toe holes 136 and 138. The left foot strap 46 includes an inner foot strap 170, a heel holder 166, an adjustable buckle 162 and an outer strap 172. The inner foot strap 170 is connected at one end to the divider wall 160 at a pivot connection 174 and at another end to the heel holder 166. The adjustable buckle 162 is attached to the heel holder 166 and adjustably connected to the outer strap 172 which is connected to the exterior side wall 156 with a pivot connection 176. The right foot strap 48 includes an inner foot strap 178, a heel holder 168, an adjustable buckle 164 and an outer strap 180. The inner foot strap 178 is connected at one end to the divider wall 160 at a pivot connection 182 and at another other end to the heel holder 168. The adjustable buckle 164 is attached to the heel holder 168 and adjustably connected to the outer strap 180 which is connected to the exterior side wall 158 with a pivot connection 184.

The overall length of the left and right foot straps 46 and 48 are adjustable by adjusting the position at which the adjustable buckles 162 and 164 attach to the outer straps 172 and 180, respectively.

The pivoting connection of the foot straps 46 and 48 allows a certain amount of longitudinal movement of the heels of the boots 42 and 44 while still holding the boots 42 and 44 in the toe holes 136 and 138.

The adjustable buckles 162 and 164 are preferably the same type as the adjustable buckles 92 and 102 on the knee support 24. The buckles 162 and 164 restrain the feet 38 from vertical movement when buckled and allow the removal or placement of the feet 38 in the toe holes 136 and 138 when un-buckled.

The foot straps 46 and 48 include the heel holders 166 and 168 which are wider than the remaining portion of the foot straps 46 and 48. The left and right heel holders 166 and 168 distribute the pressure created on the heels of the feet 38 for effectively holding the feet 38 of the user 32 in the toe holes 136 and 138.

While the kneeboard binding 22 preferably uses four straps, foot straps 46 and 48 and the calf straps 50 and 52, the kneeboard binding 22 can also use three or even two straps. To use three straps, either the foot straps 46 and 48 or the calf straps 50 and 52 are replaced with a single strap that secures both of the knees or feet. If two straps are used then the foot straps 46 and 48 are replaced with one strap and the calf straps 50 and 52 are replaced with another single strap. In either case, two strap or three strap, each of the straps can include a single buckle.

Having four straps is beneficial because it allows the user 32 to detach one leg from the kneeboard 20 while leaving the other leg attached. With one leg free and one leg attached to the kneeboard 20, the user can walk to a ski lift without undue difficulty. With one leg free, the user 32 can stand upright with one foot on the ground and the other foot in the toe hole 136 or 138, depending on if it is the right or left foot 36 in the foot support 26. The user 32 walks on the free foot 36 like normally, and uses the rearward end of the kneeboard 20 on the ground to support his or her weight from the non-free leg.

The distance between the knee support 24 and the foot support 26 is adjustable to fit a variety of users 32 and this adjustment can also accommodate a range of weight distribution preferences. The straps 46, 48, 50 and 52 are also adjustable to adapt to the user's needs for different calf and foot sizes. In the manner described the kneeboard binding 22 permits a snowboard deck 28 to be connected to a person in a kneeling position. The user 32 can manipulate his or her weight to maneuver the deck 28 on the slope 30.

A presently preferred embodiment of the present invention and many of its improvements have been described with a degree of particularity. This description is a preferred example of implementing the invention, and is not necessarily intended to limit the scope of the invention. The scope of the invention is defined by the following claims.

What is claimed:

1. A binding for attaching a person to a snowboard deck so that the person can slide down snow on a slope, comprising:
a knee support connected to the deck for receiving and supporting a knee of the person; and
a foot support connected to the deck for receiving a foot of the person.

2. A binding according to claim 1, wherein the knee support is connected at a position that is spaced apart from the foot support.

3. A binding according to claim 1, wherein the knee support further comprises:
a substantially rigid shell; and
a padding that is attached to the shell, and wherein the shell is injection molded from plastic.

4. A binding according to claim 1, wherein the knee support further comprises:
a substantially rigid shell; and
a padding that is attached to the shell, and wherein the shell is contoured to fit the knee of the person and a portion of a leg below the knee of the person.

5. A binding according to claim 4, wherein the shell and the padding have a thickness and the knee support supports the knee of the person at a position that is vertically above the deck more than the thickness of the shell and the padding.

6. A binding according to claim 5, wherein the knee support further comprises:
a base that is connected between the deck and the knee support, wherein the base connects to the deck and the shell connects to the base.

7. A binding according to claim 6, wherein the base is connected to the deck with base mounting screws and the shell has a slot which provides access to the base mounting screws.

8. A binding according to claim 6, wherein the base has an area that contacts the deck and an area that contacts the shell and the area that contacts the deck is larger than the area that contacts the shell.

9. A binding according to claim 6, wherein the base has a number of base mounting holes and is connected to the deck with base mounting screws that extend through base mounting holes and into the deck and the number of base mounting screws used to connect the base to the deck is less than the number of base mounting holes.

10. A binding according to claim 6, further comprising:
a leg connector for connecting the knee support to the leg of the person.

11. A binding according to claim 1, further comprising:
a leg connector for connecting the knee support to the leg of the person.

12. A binding according to claim 11, wherein the leg connector comprises a strap.

13. A binding according to claim 12, wherein the strap contacts a calf of the person when the knee support is connected to the leg of the person.

14. A binding according to claim 12, wherein the strap further comprises:
a substantially rigid holder that contacts and distributes a pressure from the strap to the leg of the person; and
an adjustable buckle for adjusting an amount of pressure that the holder applies to the leg.

15. A binding according to claim 12, wherein the strap has an overall length and the overall length is adjustable.

16. A binding according to claim 12, wherein the strap has an end and the strap is mounted to the knee support with a pivot connection at the end.

17. A binding according to claim 1, wherein the foot of the person is connected to the foot support with a foot connector.

18. A binding according to claim 1, wherein the person has a front portion of the foot with toes, and the foot support further comprises:
a toe hole for receiving the front portion of the foot.

19. A binding according to claim 18, wherein the foot has a bottom at the front portion, and the foot support further comprises:
a back portion of the toe hole for contacting the bottom of the foot.

20. A binding according to claim 18, wherein the foot is connected to the foot support with a foot connector.

21. A binding according to claim 18, wherein the foot connector comprises a strap that extends at least partially over the foot.

22. A binding according to claim 21, wherein the strap has a length that is adjustable.

23. A binding according to claim 21, wherein the strap has an end and the strap is mounted to the foot support with a pivot at the end.

24. A binding according to claim 1, wherein the foot support has a number of foot support mounting holes and is connected to the deck with foot support mounting screws that extend through the foot support mounting holes and into the deck and the number of foot support mounting screws used to connect the foot support to the deck is less than the number of foot support mounting holes.

25. A binding according to claim 24, wherein the foot support mounting holes are slotted.

26. A binding according to claim 24, wherein the mounting holes are positioned in the toe holes.

27. A snowboard deck in combination with a binding according to claim 1, wherein the snowboard deck comprises a metallic edge for cutting into snow.

28. A method of attaching a person to a snowboard deck for recreational purposes, comprising:
connecting and supporting a knee of the person to the snowboard deck at a middle point along a length of the deck;
connecting and supporting a foot of the person at a position spaced rearwardly of the middle point toward a rear end of the snow board; and
connecting a lower leg of the person to the snowboard with the knee in a middle position and the foot toward the rear to allow the person to assume a kneeling position above the snowboard.

29. A method as defined in claim 28, further comprising:
supporting the knee of the person separately from supporting the foot of the person.

30. A method as defined in claim 28, further comprising:
contouring the knee support to conform to the knee of the person.

31. A method as defined in claim 28, further comprising:
supporting the knee of the person at a distance spaced above the deck to provide the person with leverage to rotate the deck.

32. A method as defined in claim 28, further comprising:
attaching the deck to the person by attaching the knee support to a leg of the person.

33. A method as defined in claim 28, further comprising:
attaching the deck to the person by attaching the foot support to a foot of the person.

34. A method as defined in claim 33, further comprising:
attaching the deck to the person by attaching the knee support to a leg of the person.

35. A method as defined in claim 33, further comprising:
attaching the deck to the person by inserting the foot of the person in a boot hole in the foot support.

36. A method as defined in claim 33, further comprising:
attaching the deck to the person by extending a strap with two different ends over a leg of the person and attaching the two ends to the knee support.
